(19) United States
(12) Patent Application Publication
(10) Pub. No.: US 2012/0328136 A1
(43) Pub. Date: Dec. 27, 2012

(54) MULTIMEDIA PLAYER DEVICE

(76) Inventor: Hai-Yu CHIANG, Hsinchu Hsien (TW)

(21) Appl. No.: 13/208,843

(22) Filed: Aug. 12, 2011

(30) Foreign Application Priority Data
Jun. 24, 2011 (TW) 100211562

(51) Int. Cl. H04R 5/02

(52) U.S. Cl. 381/306

(57) ABSTRACT

A multimedia player device includes an input module for receiving multimedia data; a projecting module electrically connected with the input module so as to output images; a virtual surround processing module electrically connected with the input module so as to calculate and process sound data; an amplifier module electrically connected with the input module and the virtual surround processing module so as to receive and process the sound data from the input module and the virtual surround processing module; and a first output unit electrically connected with the amplifier module so as to output the sound data, wherein the first output unit includes more than two speaker units. By using the built-in projecting module and the virtual surround processing module, the multimedia player device achieves both visual and surround sound effects.

### BACKGROUND OF THE INVENTION

1. Field of the Invention

The present invention relates to a multimedia playback technology, and more particularly to a multi-functional multimedia player device.

2. Description of the Prior Art

The state-of-the-art home theater is composed of different devices connected by wires therebetween. The full set of home theater occupies a lot of space and is impractical to be installed in most of the people's living rooms. Besides, the cost of purchasing the full set of equipments is typically in the range of couple to tens of thousand U.S. dollars, and is usually unaffordable to normal families. In addition, if the connecting wires between the devices are not under arrangement during remodeling, the unhidden wires may affect the appearance of the place.

### SUMMARY OF THE INVENTION

The present invention is directed to a multimedia player device which uses a built-in projecting module and virtual surround processing module to achieve visual and surround sound effects.

According to an embodiment, the multimedia player device includes: an input module, for receiving multimedia data, wherein the multimedia data includes at least one of first sound data and image data; a projecting module, electrically connected with the input module so as to project the image data onto an external projection surface; a virtual surround processing module, electrically connected with the input module so as to calculate and process the first sound data to output second sound data; an amplifier module, electrically connected with the input module and the virtual surround processing module so as to receive and process one of the first sound data and the second sound data to output third sound data; and a first output unit, electrically connected with the amplifier module so as to output the third sound data, wherein the first output unit includes more than two speaker units.

The objective, technologies, features and advantages of the present invention will become more apparent from the following description in conjunction with the accompanying drawings, wherein certain embodiments of the present invention are set forth by way of illustration and examples.

### BRIEF DESCRIPTION OF THE DRAWINGS

FIG. 1 is a block diagram illustrating the multimedia player device according to an embodiment of the present invention;

FIG. 2 is a block diagram illustrating the multimedia player device according to an embodiment of the present invention;

FIG. 3 is a block diagram illustrating the multimedia player device according to an embodiment of the present invention;

FIG. 4 is a block diagram illustrating the multimedia player device according to an embodiment of the present invention;

FIG. 5 is a schematic diagram illustrating the multimedia player device in actual use according to an embodiment of the present invention;

FIG. 6 is a schematic top-view diagram illustrating the multimedia player device in actual use according to an embodiment of the present invention;

FIG. 7a, FIG. 7B and FIG. 7C are schematic diagrams illustrating the projecting positions of the projecting module according to an embodiment of the present invention.

### DESCRIPTION OF THE PREFERRED EMBODIMENT

The detail description is provided below and the preferred embodiments described are only for the purpose of description rather than for limiting the present invention.

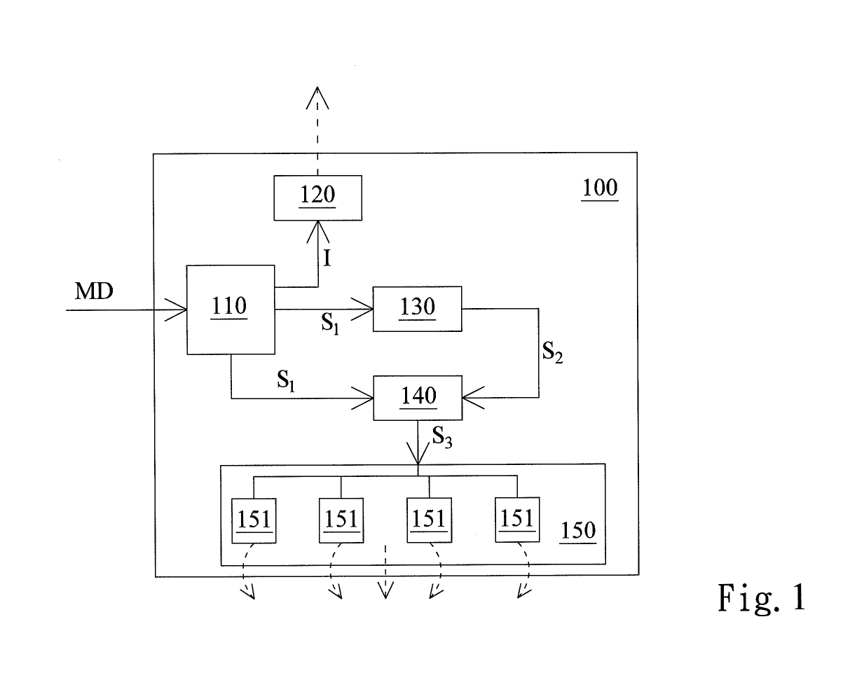

Referring to FIG. 1, there is illustrated a block diagram of a multimedia player device according to an embodiment. As illustrated in the figure, the multimedia player device 100 includes an input module 110, a projecting device 120, a virtual surround processing module 130, an amplifier module 140 and a first output unit 150. As illustrated in FIG. 1, the input module 110 is for receiving externally input multimedia data MD, wherein the multimedia data MD includes at least one of first sound data Si and image data I. And the input module 110 transmits the image data I and the first sound data Si respectively to the projecting module 120 and the virtual surround processing module 130 electrically connected with the input module 110. The projecting module 120 here is for projecting the image data I onto an external projection surface. The virtual surround processing module 130 is for calculating and processing the first sound data S₁ to output second sound data S₂. The amplifier module 140 is electrically connected with the input module 110 and the virtual surround processing module 130 so as to receive and process the first sound data S₁ or the second sound data S₂ to output third sound data S₃. Finally, the first output unit 150 is electrically connected with the amplifier module 140 so as to output the third sound data S₃, wherein the first output unit 150 includes more than two speaker units 151, which can be but not limited to be left and right main channel speakers and left and right surround speakers. The aforementioned virtual surround processing module 130 produces virtual surround effect for the received first sound data S₁ by way of calculation, which is then through the drive of the amplifier module 140 delivered to the speaker units 151 to present the surround effect which would originally created by 5.1 channel speakers disposed at different places.

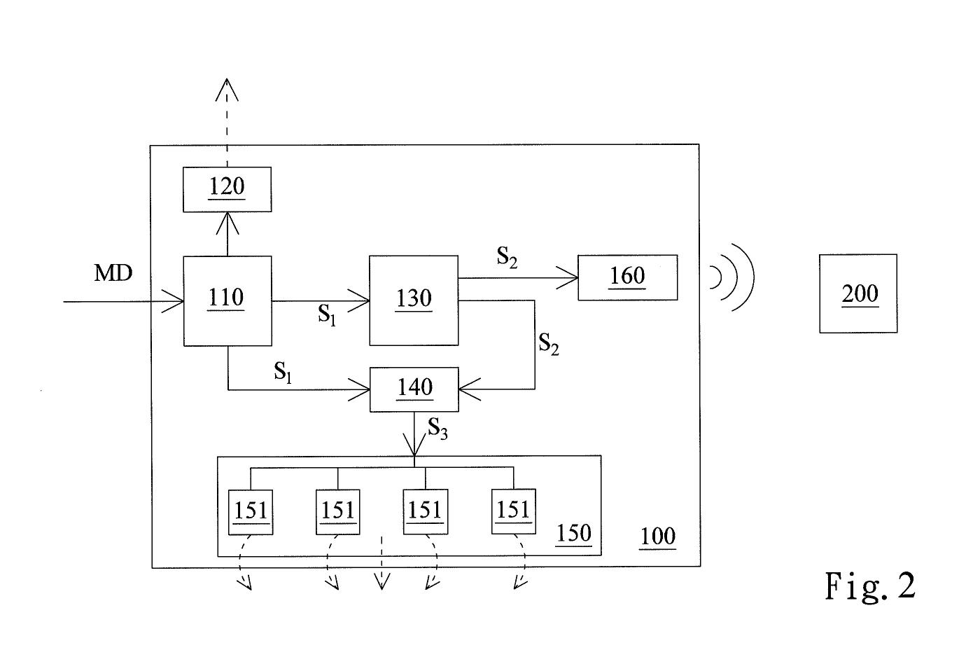

Continuing the above description, the multimedia player device 100 according to an embodiment illustrated in FIG. 2 further includes a wireless bass module 160 electrically connected with the virtual surround processing module 130 so as to send a bass portion of the second sound data S₂ to an external subwoofer bass device 200. Transmitting the sound content wirelessly to the external subwoofer bass device 200 avoids the hassle of making wire connections and the issue of showing a bunch of uncovered wires.

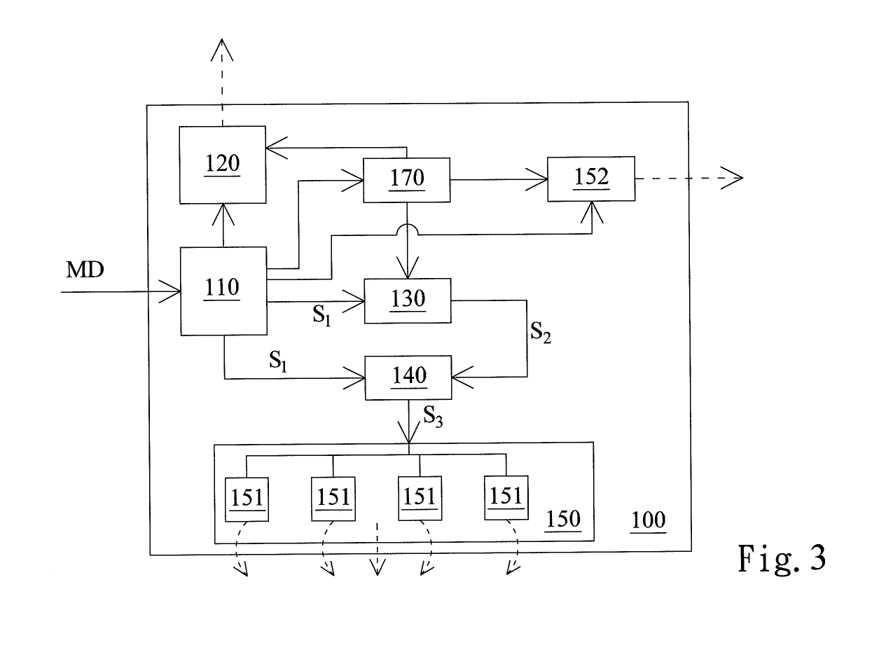

Furthermore, according to another embodiment as illustrated in FIG. 3, the multimedia data MD may be compressed or uncompressed digital audio/video data. In order to decode the compressed digital audio/video data, the multimedia player device 100 may further include a decoding module 170. The decoding module 170 may be electrically connected with the input module 110 and send the decoded digital audio/video data respectively to the virtual surround processing module 130 and the projecting module 120 to output sounds and images, or send the decoded digital audio/video data to a second output unit 152 to output directly. On the other hand, if the multimedia data is the uncompressed digital audio/video data, the digital audio/video data can be respectively sent to the virtual surround processing module 130 and the projecting module 120 without being first decoded by the decoding module 170. It can be understood that if the input multimedia data neither has to be decoded, nor has to be processed by the virtual surround processing module 130, then the images and sounds sent from the input module 110 can be directly output by the second output unit 152 having the direct electrical connection with the input module 110.

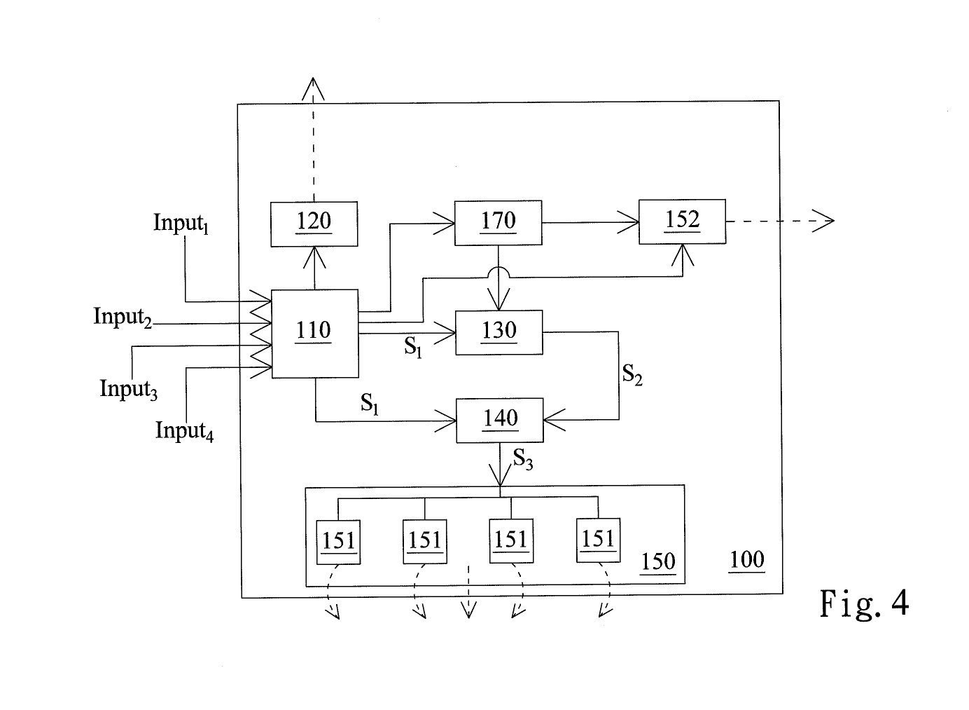

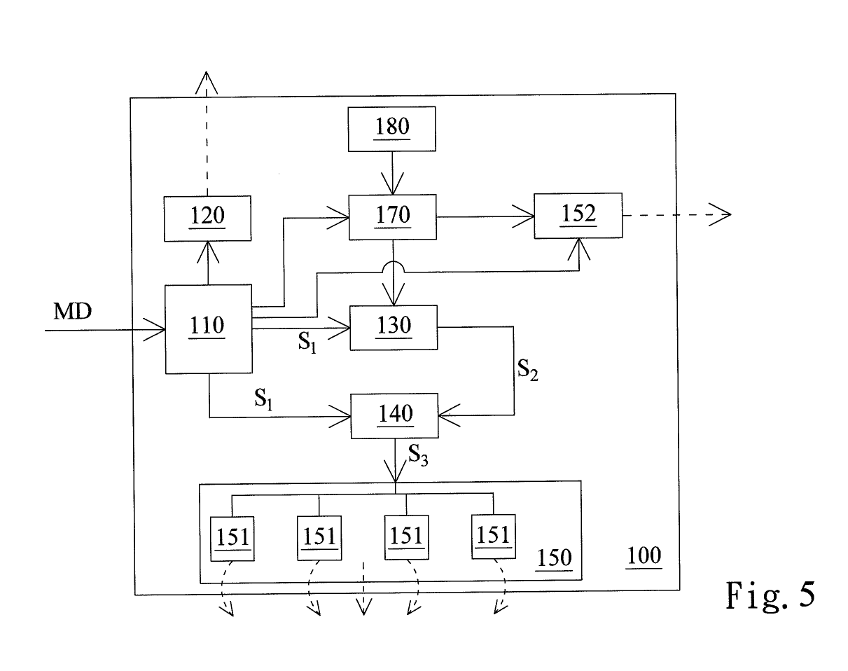

Additionally, according to the present invention, the multimedia data can be input from various kinds of external interfaces or can be read directly internally from the multimedia player device 100. FIG. 4 schematically illustrates the embodiment where the multimedia data is input from outside; FIG. 5 schematically illustrates the embodiment where the multimedia data is read directly internally from the multimedia player device 100. First, referring to FIG. 4, the input module 110 may receive the multimedia data as Inputs from a network, Input₂ from an external audio/video device, Input₃ from an external multimedia reading device, or Input₄ from an external audio source device. The multimedia data received as Input₂ from the external audio/video device may include for example high quality audio/video multimedia data transmitted through HDMI (High Definition Multimedia Interface). The multimedia data received as Input₃ from the multimedia reading device may include the multimedia data read from the external devices connected through USB (Universal Serial Bus), such as a hard disk, a DVD loader (Digital Video Disc Loader), a BD loader (Blu-ray Disc loader), and a gaming console. According to an embodiment, the multimedia data received as Input₄ from the external audio source device may include left and right audio channel input, ear piece input, microphone input, compressed or uncompressed digital audio source input through fiber optics or a coaxial cable, and from a handheld audio/video device such as an iPod, iPhone, iPad, and the like.

Continuing the above description, the multimedia player device 100 according to an embodiment as illustrated in FIG. 5 may also has a built-in multimedia reading unit 180 for reading the compressed digital audio/video data on an optical disc, wherein the multimedia reading unit 180 is connected with the decoding module 170 so as to decode the retrieved digital audio/video data. The multimedia reading unit 180 here can include but not limited to a hard disk, an optical audio/video disc ROM such as a DVD-ROM and a BD-ROM. It can be understood that the multimedia player device 100 may also be equipped with both the input module 110 having various kinds of external input interfaces and the built-in multimedia reading unit 180 to afford different input selections to a user. The structure and functions of such a multimedia player device 100 have been largely provided above and would be omitted here.

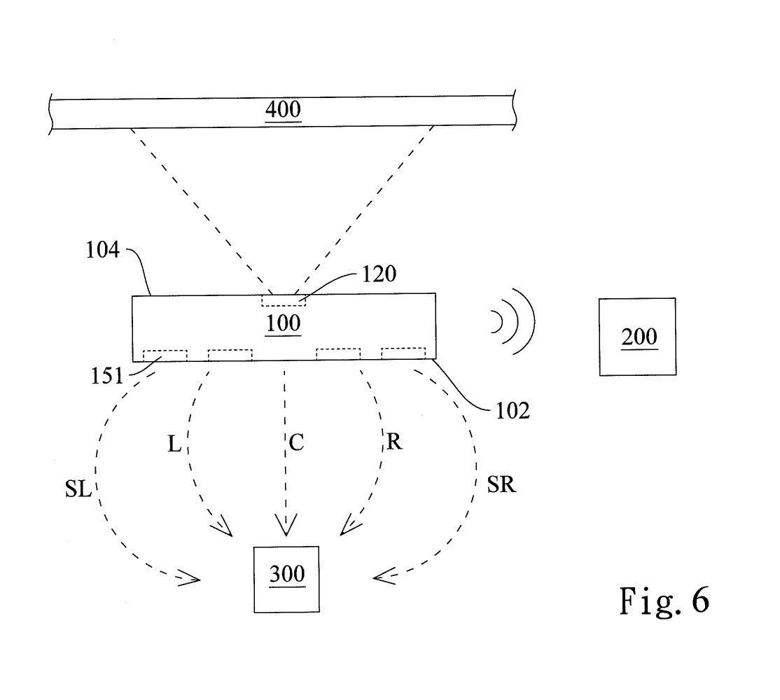

Finally, referring to FIG. 6, there is shown a schematic top-view diagram illustrating a multimedia player device in actual use according to an embodiment. As illustrated in the figure, when a user 300 is using the multimedia player device 100 in a room, the multimedia player device 100 can produce a left surround sound effect SL, a right surround sound effect SR, a left main channel sound effect L, a right main channel sound effect R and a center sound effect C by way of internal calculation, and output from the speaker units 151 in the front 102 of the multimedia player device 100. Moreover, the heavy bass portion may also be transmitted wirelessly to an external subwoofer bass device 200 to create heavy bass or super heavy bass effects, and the image portion would be projected by the projecting module 120 located at the back 104 of the multimedia player device 100 onto the projection surface 400, such as a wall or a screen. Therefore, the user 300 may have both visual and auditory enjoyments at the same time. Furthermore, the multimedia player device according to the present invention has no extra external wire connections, and therefore may maintain neatness of the room and does not occupy extra space.

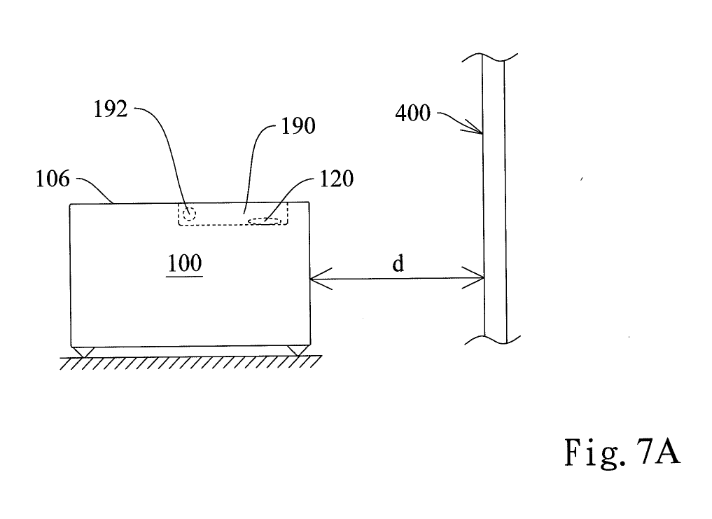

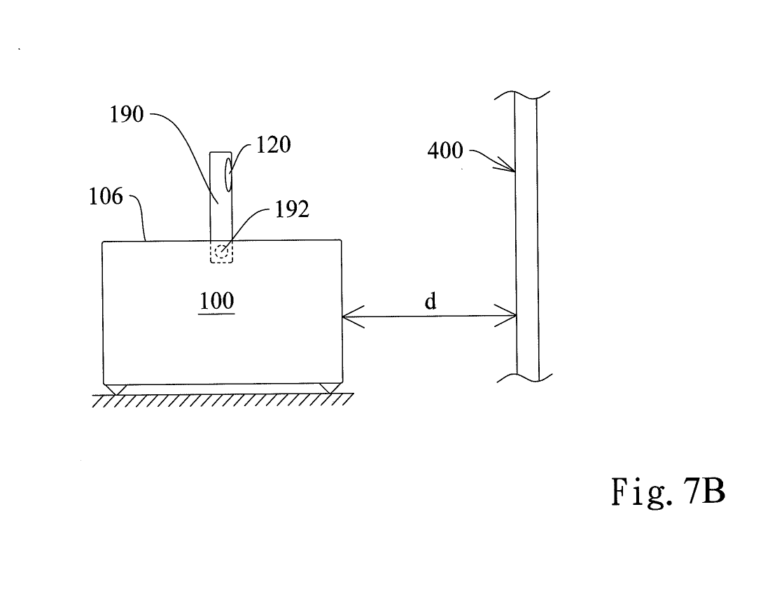

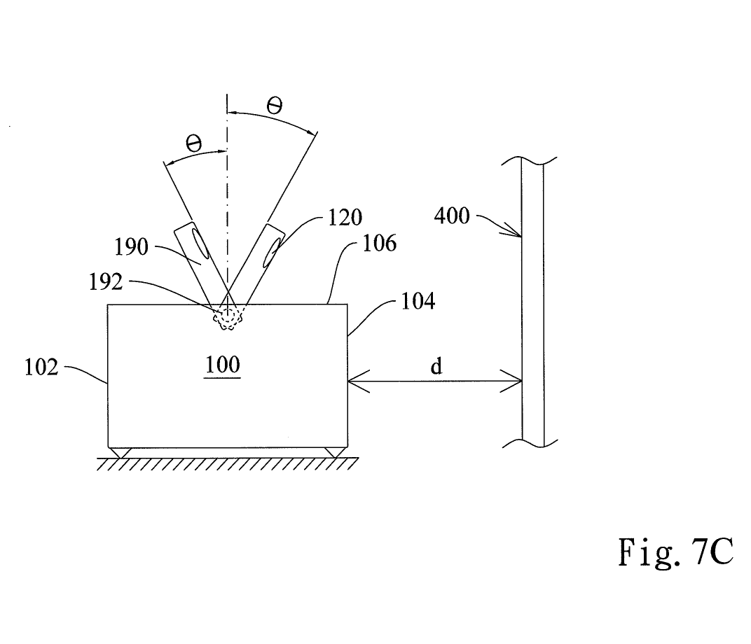

Besides, continuing from the above description, the projecting module 120 as illustrated in FIG. 6 projects from a position at the back 104 of the multimedia player device 100, but it can be understood that the projecting position of the projecting module 120 may also be over the multimedia player device 100. Referring to FIG. 7A, FIG. 7B and FIG. 7C, there are illustrated an embodiment in which the projecting position of the projecting module is above the top 106 of the multimedia player device 100. Referring first to FIG. 7A, the multimedia player device 100 has a plate-shaped piece 190 coupled with the projecting module 120 and located under the top 106 of the multimedia player device 100. When projection is not needed at the time, the projecting module 120 may be stored in the multimedia player device 100 with the plate-shaped piece 190, so that the multimedia player device 100 has a neat appearance. When projection is needed, as illustrated in FIG. 7B and FIG. 7C, the plate-shaped piece 190 can be flipped open so that the lens of the projecting module 120 is located above the multimedia player device 100. The plate-shaped piece 190 pivots with a pivot portion 192 to flip and fold, and adjusts the projection angle of the projecting module 120 according to the positions of and distance d between the projecting module 120 and the projection surface 400. The plate-shaped piece 190 here may pivot back and forth such as shown by the variation of angle Θ in the figure for convenience of use of the user.

According to the foregoing description, one characteristic of the multimedia player device according to the present invention is that it is equipped with multiple kinds of modules for accessing the multimedia data, and when collocating with the built-in decoding module, play the compressed digital data in all currently existing formats, thereby greatly facilitating the usage. Moreover, the virtual surround processing module and the plurality of speaker units within the device may create surrounding effect which originally requires more than six speakers, thereby affording the user with the same class of experience as a home theater without demanding for the high cost. Additionally, compared to the prior art home theater equipment, the multimedia player device does not have extra external wire connections, and occupies less space, and is therefore more suitable for normal families.

In summary, the multimedia player device according to the present invention uses the built-in projecting module and virtual surround processing module to achieve both visual and surround sound effects.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A multimedia player device comprising:
an input module, for receiving multimedia data, wherein the multimedia data comprises at least one of first sound data and image data;
a projecting module, electrically connected with the input module so as to project the image data onto an external projection surface;
a virtual surround processing module, electrically connected with the input module so as to calculate and process the first sound data to output second sound data;
an amplifier module, electrically connected with the input module and the virtual surround processing module so as to receive and process one of the first sound data and the second sound data to output third sound data; and
a first output unit, electrically connected with the amplifier module so as to output the third sound data, wherein the first output unit comprises more than two speaker units.

2. The multimedia player device according to claim 1, wherein the multimedia data is compressed or uncompressed digital audio/video data, and when the multimedia data is the compressed audio/video data, the multimedia player device further comprises a decoding module electrically connected with the input module so as to decode the digital audio/video data, and send the decoded digital audio/video data to the virtual surround processing module and the projecting module; and when the multimedia data is the uncompressed audio/video data, the audio/video data is directly sent to the virtual surround processing module and the projecting module.

3. The multimedia player device according to claim 2, further comprising a multimedia reading unit electrically connected with the decoding module so as to read a multimedia storage unit to provide the digital audio/video data.

4. The multimedia player device according to claim 3, wherein the multimedia reading unit comprises a hard disk, an optical audio/video disc ROM or a gaming console.

5. The multimedia player device according to claim 2, further comprising a second output unit electrically connected with the input module and the decoding module so as to output one of the multimedia data and the decoded digital audio/video data.

6. The multimedia player device according to claim 1, further comprising a wireless bass module electrically connected with the virtual surround processing module so as to send a bass portion of the third sound data to an external subwoofer bass device.

7. The multimedia player device according to claim 1, wherein the input module is for receiving the multimedia data input from a network, from an external audio/video device, from an external multimedia reading device or from an external audio source device.

8. The multimedia player device according to claim 1, wherein a projecting position of the projecting device is above the top of the multimedia player device, and the multimedia player device comprises a plate-shaped piece coupled with the projecting device and located under the top of the multimedia player device so as to store the projecting module inside the multimedia player device.

9. The multimedia player device according to claim 8, wherein the plate-shaped piece has a pivot portion, and the plate-shaped piece uses the pivot portion as the pivoting axis to adjust a projection angle of the projecting module
